(19) United States
(12) Patent Application Publication
(10) Pub. No.: US 2013/0342494 A1
(43) Pub. Date: Dec. 26, 2013

(54) AUXILIARY INPUT DEVICE, AND ELECTRONIC DEVICE AND ELECTRONIC SYSTEM INCLUDING THE AUXILIARY INPUT DEVICE

(71) Applicant: Hsu-Hong Feng, Taoyuan County (TW)

(72) Inventor: Hsu-Hong Feng, Taoyuan County (TW)

(73) Assignee: HTC CORPORATION, Taoyuan County (TW)

(21) Appl. No.: 13/528,849

(22) Filed: Jun. 21, 2012

(51) Int. Cl. G06F 3/044

(52) U.S. Cl. 345/174

(57) ABSTRACT

An auxiliary input device is provided for an electronic device including a capacitive touch sensor. The auxiliary input device includes at least one key, which includes an upper conductive layer, a lower conductive layer, and at least one supporting element. The lower surface of the lower conductive layer has a specific pattern. The supporting element is disposed between the two conductive layers such that there is a distance maintained between the two conductive layers. When the auxiliary input device is disposed on the capacitive touch sensor and the key is pressed by a conductive object, the upper conductive layer and the specific pattern of the lower conductive layer can be electrically conductive with each other so that the capacitive touch sensor can detect the contact of the specific pattern. When the capacitive touch sensor detects the contact of the specific pattern, the electronic device executes a corresponding function.

### TECHNICAL FIELD

The invention relates to an auxiliary input device, and also relates to an auxiliary input device for a capacitive touch sensor, and an electronic device and electronic system including the auxiliary input device.

### BACKGROUND

Currently, there are many types of portable electronic devices, such as smart phones or table PCs, which can be connected to an external display device, such as a display, a television or a projector so that the image of the portable electronic device is displayed on the big screen of the external display device to achieve a better viewing effect.

In the majority of the above portable electronic devices, a virtual keyboard is displayed on a touch screen as a text input interface for users. However, a virtual keyboard may not be suitable because the dimension of the screen of a portable electronic device is limited and many keys cannot be displayed concurrently. Also, the small virtual keys on the screen may be difficult to be operated on. Further, when the portable electronic device is connected to an external display device, the user will naturally focus on the screen of the external display device and not the screen of the non-portable electronic device itself. The smooth surface of the touch screen is difficult for the user to sense the positions of the keys, and the sensitive touch screen also easily leads the user to press the wrong key. Accordingly, the text input speed with a virtual keyboard is slower than that with a physical keyboard. Further, many other inconveniences may result.

### SUMMARY

An exemplary embodiment of the disclosure provides an auxiliary input device, and an electronic device and an electronic system including the auxiliary input device. The above-mentioned auxiliary input device includes a plurality of features of a physical keyboard and is correlative with a virtual keyboard for enhancing the input speed and the convenience of the virtual keyboard.

An exemplary embodiment of the disclosure provides an auxiliary input device applicable on an electronic device, and the electronic device includes a capacitive touch sensor. The above auxiliary input device at least includes a key, and the key includes an upper conductive layer, a lower conductive layer and at least one support element. The lower conductive layer is disposed under the upper conductive layer, and the bottom surface of the lower conductive layer has a specific pattern. The support element is disposed between the upper conductive layer and the lower conductive layer to maintain a distance between the upper conductive layer and the lower conductive layer. When the auxiliary input device is placed on the capacitive touch sensor and the key receives a contact pressure of a conductive object, the upper conductive layer and the specific pattern of the lower conductive layer are electrically conductive with each other so that the capacitive touch sensor detects the contact of the above specific pattern. When the capacitive touch sensor detects the contact of the specific pattern, the electronic device executes a function corresponding to the specific pattern.

An exemplary embodiment of the disclosure provides an electronic device, and the electronic device includes a main body and the above-mentioned auxiliary input device. The main body includes a capacitive touch sensor. The auxiliary input device may be placed on the capacitive touch sensor.

An exemplary embodiment of the disclosure provides an electronic system, and the electronic system includes a display device and the above electronic device. The electronic device is coupled with the electronic system via wire or wireless means. The electronic device includes a main body and the above-mentioned auxiliary input device. The main body includes a capacitive touch sensor. The auxiliary input device is placed on the capacitive touch sensor. When the capacitive touch sensor detects the contact of the specific pattern, the electronic device executes the function corresponding to the specific pattern to control the display device for displaying an image.

According to the exemplary embodiments of the disclosure, an auxiliary input device provided may be configured on a capacitive touch sensor and is correlative with a virtual keyboard of the electronic device. The above auxiliary input device includes a texture for providing a user to sense the position of the key by contact and has sufficient support strength for the user not to unintentionally active the key. These features that are substantially similar to those of a physical keyboard may increase the input speed and the convenience of a virtual keyboard.

The invention and certain merits provided by the invention can be better understood by way of the following exemplary embodiments and the accompanying drawings, which are not to be construed as limiting the scope of the invention.

### BRIEF DESCRIPTION OF THE DRAWINGS

FIG. 1 is a schematic diagram of an electronic device according to an exemplary embodiment of the disclosure.

FIGS. 2A to 2B are schematic diagrams of a type of key according to an exemplary embodiment of the invention.

FIG. 3 is a schematic diagram of the specific patterns of keys according to an exemplary embodiment of the invention.

FIGS. 4A and 4B are respectively a schematic diagram of a key according to an exemplary embodiment of the invention.

FIG. 5 is a schematic diagram of the specific patterns of keys according to an exemplary embodiment of the invention.

FIG. 6 is a schematic diagram of an electronic device according to an exemplary embodiment of the invention.

FIG. 7 is a schematic diagram of an electronic system according to an exemplary embodiment of the invention.

### DETAILED DESCRIPTION OF DISCLOSED EMBODIMENTS

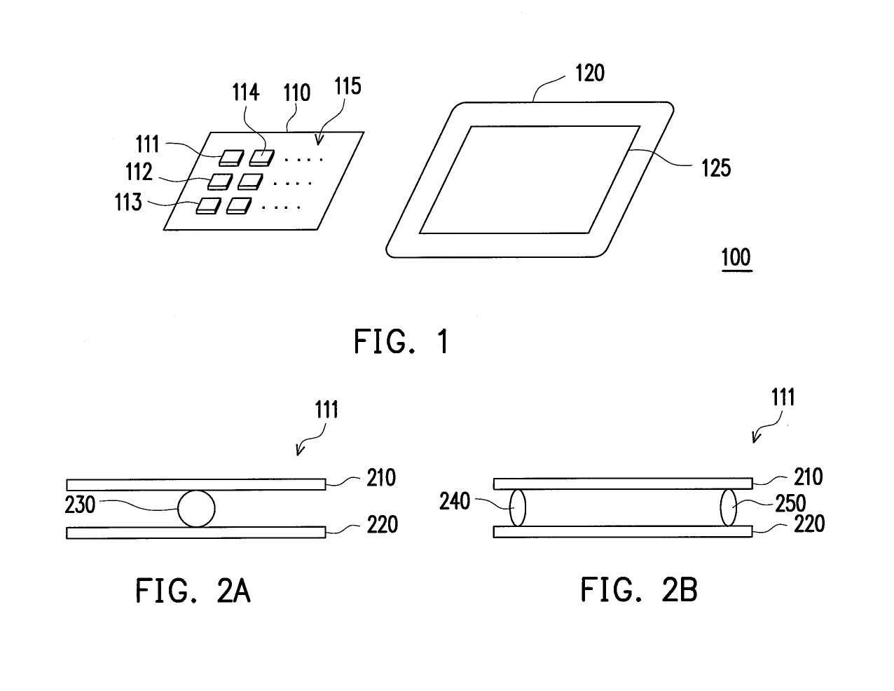

FIG. 1 is a schematic diagram of an electronic device 100 according to an exemplary embodiment of the disclosure. The electronic device 100 may be a smart phone, a personal digital assistant (PDA), a tablet PC or a notebook computer. The electronic device 100 includes an auxiliary input device 110 and a main body 120. The main body 120 includes a capacitive touch sensor 125. The capacitive touch sensor 125 is, for example, a touch panel or a touch display of the electronic device 100.

The auxiliary input device 110 may be placed on the capacitive touch sensor 125. The auxiliary input device 110 is an independent entity and does not have electrical connection with the main body 120. The auxiliary input device 110 can be physically separated from the main body 120.

The auxiliary input device 110 includes at least a key. In this exemplary embodiment, the auxiliary input device includes keys 111 to 114, for example. Referring to FIG. 1, the auxiliary input device 110 also includes at least a texture. The texture may provide the user to identify the positions of the keys by a contact. The texture disposed on the upper surface 115 of the auxiliary input device 110 is used for differentiating the positions of the keys. The texture may include an indented pattern, a protruded pattern, a convex surface, a concave surface or a combination of the above textures. For example, the texture may mark the position of the key itself, the position of a portion of the key or the position of a complete profile of the key, or the position of the interval between keys. Accordingly, the user can ascertain the position of the key of the auxiliary input device 110 by contact with hands in absent of any visual contact.

The structure of each key of the auxiliary input device 110 is similar. Key 111 is used as an illustrative example, and the structures of other keys are also similar. FIGS. 2A and 2B are schematic diagrams of the key 111. The key 111, as illustrated in FIG. 2A, includes an upper conductive layer 210, a lower conductive layer 220, and a support element 230. The lower conductive layer 220 is disposed under the upper conductive layer 210. The support element 230 is made of a flexible insulation material, and is disposed to maintain a distance between the upper conductive layer 210 and the lower conductive layer 220. Alternatively speaking, the support element 230 may be a rubber particle or an air pocket encapsulated by an insulation thin film.

The support element 230 has a certain supporting ability for maintaining the distance between the upper conductive layer 210 and the lower conductive layer 220 unchanged when the key 111 is not subjected to a contact pressure. When the auxiliary input device 110 is placed on the capacitive touch sensor 125, and the key 111 receives a contact pressure from a conductive object (for example, a stylus or a hand of an user), the support element 230 is compressed so that the upper conductive layer 210 and the lower conductive layer 220 are in contact, resulting in that the upper conductive layer 210 and the lower conductive layer 220 are mutually electrically conductive with each other and the capacitive touch sensor 125 thereunder can detect one or more contact events.

The key 111 is not limited to include just one support element. The key 111 may include two support elements 240 and 250 as shown in FIG. 2B. In other exemplary embodiments, the key 111 may include three or more support elements.

If the electronic device 100 provides a virtual keyboard through the capacitive touch sensor 125 for the user to input text, the key positions of the auxiliary input device 110 can be designed to be the same as the key positions of the virtual keyboard of the electronic device 100. Accordingly, the auxiliary input device 110 can transform the virtual keyboard of the electronic device 100 to a physical keyboard. Due to the supporting ability of the support element 230, the user can rest his/her fingers on the keys of the auxiliary input device 110 or search for keys without activating the keys. The texture of the auxiliary input device 110 provides a tactile sensation for the user to ascertain a correct correspondence between his/her finger and a particular key to improve the input accuracy. Hence, the input rate and the convenience of a virtual keyboard of an electronic device 100 are comparable to those of a traditional physical keyboard. The auxiliary input device 110 may be fabricated into a foldable or rollable thin film with soft and light materials. Accordingly, the storage or the carrying of the auxiliary input device 110 is much more convenient than those of a conventional physical keyboard.

The bottom surface of the lower conductive layer of the keyboard of the auxiliary input device 110 (for example, the lower conductive layer 220 of the key 111) may include a three-dimensional specific pattern. Accordingly, the lower conductive layer 220 is like a stamp. When the key receives a contact pressure from a conductive object, the upper conductive layer and the special pattern of the lower conductive layer are electrically conductive with each other so that the special pattern of the lower conductive layer contacts the capacitive touch sensor 125 to concurrently generate a plurality of contact events, wherein the position of each contact event is different. In this exemplary embodiment, the capacitive touch sensor 125 may include multi-touch function and identification ability. Accordingly, the electronic device 100 uses the capacitive touch sensor 125 to detect the contacts of the different special patterns in order to identify the different keys with the different special patterns.

The electronic device 100 may include a sensor chip and a driver of the capacitive touch sensor 125. The above-mentioned special pattern identification mechanism can be implemented at the sensor chip or driver. When the capacitive touch sensor 125 detects a contact of any one of the special patterns, the electronic device 100 may execute a predetermined function of the key corresponding to the special pattern.

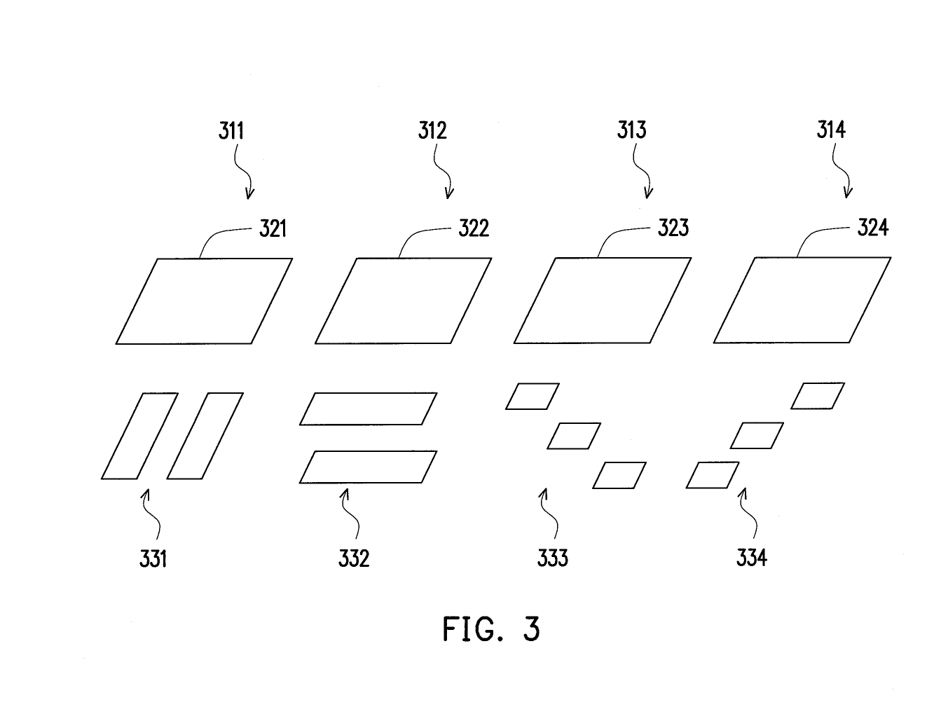

For example, FIG. 3 illustrates four keys 311 to 314 of the auxiliary input device 110. For the sake of simplicity, the support elements of the keys 311 to 314 are omitted in FIG. 3. The key 311 includes an upper conductive layer 321 and a lower conductive layer 331; the key 312 includes an upper conductive layer 322 and a lower conductive layer 332; the key 313 includes an upper conductive layer 323 and a lower conductive layer 333; the key 314 includes an upper conductive layer 324 and a lower conductive layer 334. The upper conductive layers 321 to 324 may be configured in sheet form, while the lower conductive layers 331 to 334 are made into different shapes of special patterns. The electronic device 100 can identify and differentiate the keys 311 to 314 according the differences between the special patterns of the lower conductive layers 331 to 334.

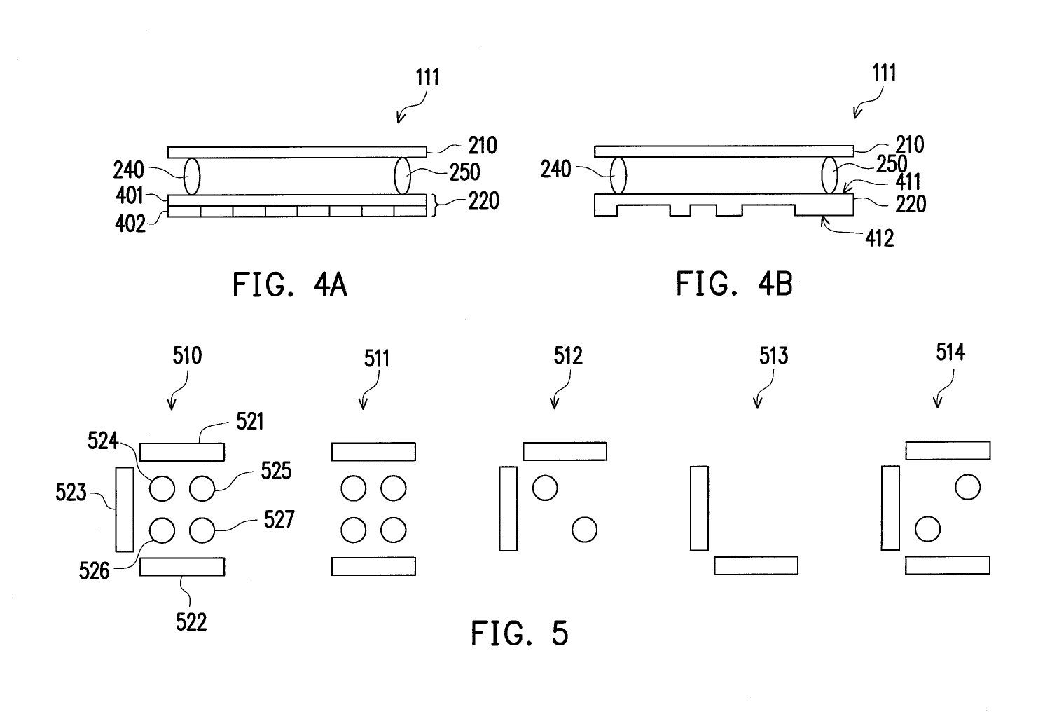

The above-mentioned keys with the special patterns may use the designs as illustrated in FIG. 4A or 4B. Using the key 111 illustrated in FIG. 2A as an example, the lower conductive layer 220 of the key 111 in FIG. 4A includes conductive layer 401 and another conductive layer 402. The conductive layer 401 is disposed above the conductive layer 402. The lower conductive layer 220 is formed with the combination of the conductive layers 401 and 402. The shape of the conductive layer 401 and the shape of the conductive layer 210 may also be configured in sheet form as the shape of the upper conductive layers 321 to 324 shown in FIG. 3. The conductive layer 402 may be made into shapes of various special patterns.

In FIG. 4B, the lower conductive layer 220 of the key 111 includes an upper surface 411 and a lower surface 412, wherein the shape of the upper surface 411 is the same as that of the upper conductive layer 210, for example both have flat surfaces. The shape of the bottom surface 412 may constitute various three-dimensional special patterns, similar to the pattern of a stamp.

As shown in FIG. 3, the lower conductive layer of a key may be fabricated into a plurality of separated conductive units to form the special pattern of the key. However, when the key is subjected to a contact pressure, the upper layer may not be in contact with each of the conductive units. The capacitive touch sensor 125 may detect an incomplete special pattern, leading to an erroneous identification of the key. If the design in FIG. 4A or 4B is adopted, the bottom part of the lower conductive layer 220 (for example, the conductive layer 402) includes one or several conductive units to form a special pattern, and the entire piece of the top part of the lower conductive layer 220 (for example, conductive layer 401) can be electrically connected to each conductive unit. Accordingly, when the key in FIG. 4A or 4B is subjected to a contact pressure, as long as the upper conductive layer contacts any part of the lower conductive layer, the conductive units of the special pattern are all electrically conductive with the upper conductive layer. The problem of an erroneous identification is thereby precluded.

The special pattern underneath the key allows the capacitive touch sensor 125 to identify the key according to the relative positions of the contact events. One consideration of using relative positions to identify the key is to be able to preclude a requisite of an accurate alignment between the auxiliary input device 110 and the capacitive touch sensor 125. Even when the auxiliary input device 110 is shifted or rotated on the capacitive touch sensor 125, the relative positions of the plurality of contact events caused by the specific patterns remain unchanged; hence, the capacitive touch sensor 125 can still accurately identify the key.

The special patterns of the lower conductive layers of the keys of the auxiliary input device 110 may be different subsets of one set constituted by a plurality of conductive units. In the exemplary embodiment illustrated in FIG. 5, seven conductive units 521 to 527 form one set 510. The special patterns of the lower conductive layer of four keys of the auxiliary input device 110 are respectively 511 to 514, and the special patterns are different subsets of the one set 510. The special pattern 511 is a subset formed with the conductive units 521, 522 and 524 to 527. The special pattern 512 is a subset formed with the conductive units 521, 523, 524 and 527. The special pattern 513 is a subset formed with the conductive units 522 and 523. The special pattern 514 is a subset formed with the conductive units 521 to 523, 525 and 526. The special pattern 510 is a union of the special patterns 511 to 514. It is understood by a person of ordinary skill that the quantity, the size or the shape of the conductive units in forming the special patterns are not limited in the disclosure. The conductive units in a special pattern may have the same or different shapes and sizes.

When one of the keys corresponding to the special patterns 511 to 514 receives a contact pressure from a conductive object, the conductive units of the lower conductive layer, which contact the capacitive touch sensor 125, generates a plurality of contact events. The electronic device 100 may identify each conductive unit according to the relative positions of these contact events to further identify the special patterns formed by these conductive units and the corresponding key.

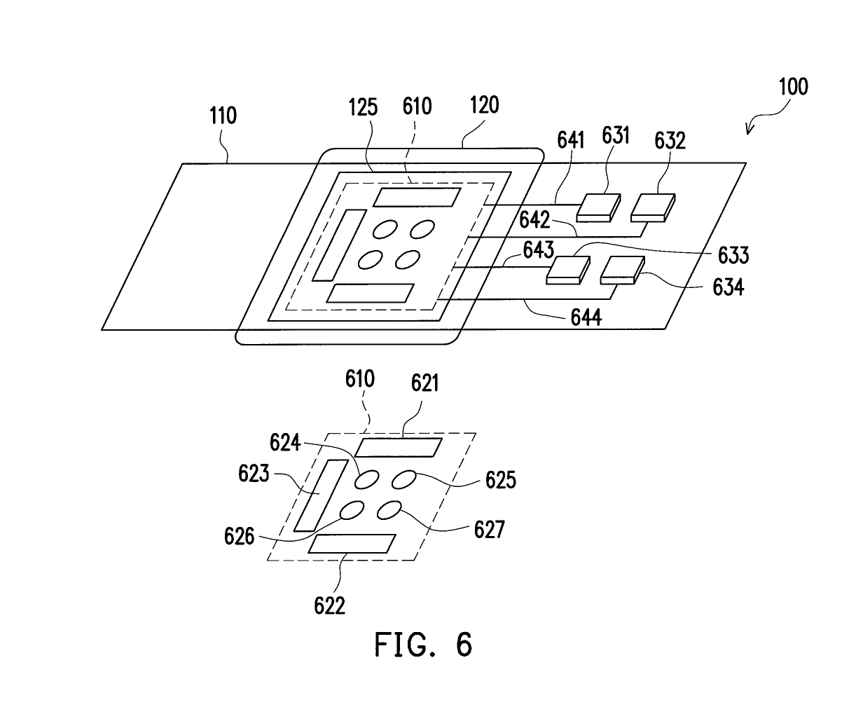

FIG. 6 is a schematic diagram of an electronic device 100 and an auxiliary input device 110, wherein the area of the auxiliary input device 110 is greater than the area of the capacitive touch sensor 125. In the auxiliary input device 110 of this exemplary embodiment, in addition to the texture at the position of the instruction key, the auxiliary input device 110 also includes keys 631 to 634, conductive wires 641 to 644 and a common conductive layer 610.

The common conductive layer 610 can be placed on the capacitive touch sensor 125. The area of the common conductive layer 610 is less than or equal to the area of the capacitive touch sensor 125. The common conductive layer 610 is formed with a plurality of isolated conductive units 621 to 627. Each of the keys 631 to 634 correspond to one subset of the conductive units 621 to 627, and the keys 631 to 634 correspond to different subsets.

Each of the conductive wires 641 to 644 is connected to the lower conductive layer of one of the keys 631 to 634 and the subset corresponding to that key. For example, if the key 631 corresponds to the subset constituted with the conductive units 621 to 623, the conductive wire 641 connects to the lower conductive layer of the key 631 and the conductive units 621, 622 and 623. If the key 632 corresponds to the subset constituted with the conductive units 624 to 627, the conductive wire 642 connects with the lower conductive layer of the key 632 and the conductive unit 624, 625, 626, and 627.

When one of the keys 631 to 634 receives a contact pressure of a conductive object, the upper conductive layer, the lower conductive layer of the key, and the subset of the corresponding key are electrically conductive with one another, allowing the corresponding subset of the key to generate a plurality of contact events on the capacitive touch sensor 125. The electronic device 100 can identify the subset according to the relative positions of the plurality of contact events to identify the key.

The auxiliary input device 110 of FIG. 6 uses the conductive units and the set of the conductive units as shown in FIG. 5. Different combinations of the conductive units of just one set are used to differentiate the different keys. Accordingly, it is only required that the entire surface of the conductive units to be smaller than the area of the capacitive touch sensor 125. The area of the auxiliary input device 110 itself, however, is not limited. Accordingly, the area of the auxiliary input device 110 can exceed the area of the capacitive touch sensor and the number of the keys can be increased or bigger keys can be used. For example, the auxiliary input device 110 may be made into a dimension similar to that of a full size keyboard of a desktop personal computer, including all the keys of a full size keyboard. Accordingly, the portable electronic device will have a keyboard similar to that of a desktop personal computer.

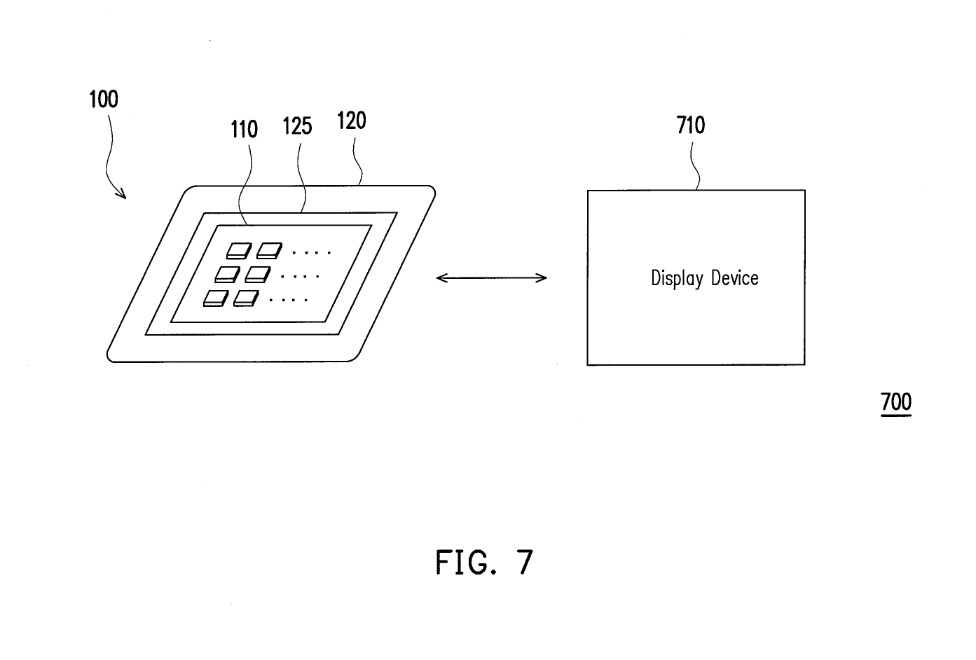

FIG. 7 is a schematic diagram of an electronic system 700 according to an exemplary embodiment of the disclosure. The electronic system 700 includes a display device 710 and the electronic device 100. The electronic device 100 is coupled to the display device 710 using wire or wireless means. As shown in FIG. 7, the auxiliary input device 110 of the electronic device 100 is placed on the capacitive touch sensor 125. Although the auxiliary input device 110 in FIG. 7 is a similar type of but smaller than the auxiliary input device as shown in FIG. 1, it is understood by a person of ordinary skill that the exemplary embodiment of the disclosure is not limited as such. In other exemplary embodiments, the auxiliary input device 110 in FIG. 7 can be replaced by a device with a bigger area as shown in FIG. 6.

When the key of the auxiliary input device 110 receives a contact pressure, the capacitive touch sensor 125 can detect the contact of a corresponding special pattern. When the capacitive touch sensor detects the contact of the specific pattern, the electronic device then executes a function corresponding to the above specific pattern to control the display device in displaying a corresponding image. For example, the display device 710 may be a display, a television, a projector, and the above function of the electronic device 100 may include generating an image according to the detection of the specific pattern and providing that image to the display device for being displayed. Alternatively speaking, the electronic device 100 may accept an operation of a user via the auxiliary input device 110 and display the above generated image on the display device 710. The display device 710 may be a personal computer or a digital television with a set-top box, and the above function of the electronic device is a transmission of an input signal to a display device 710 based on a detected specific pattern. The display device 710 generates and displays the image according to the display device. Under this situation, the electronic device 100 is comparable to a remote control of the display device 710, allowing the user to control the display device 710 via the auxiliary input device 110.

According to the above disclosure, the auxiliary input device may provide the support strength and the texture may be similar to those of a physical keyboard. Hence, the input efficiency and accuracy of the virtual keyboard of the touch display device are not inferior from those of a physical keyboard. The auxiliary input device of the exemplary embodiment of the disclosure may use a light and flexible material to fabricate a foldable and rollable thin film; hence, the storage and the carrying of the auxiliary input device are more convenient than those of a traditional physical keyboard. The auxiliary input device of the exemplary embodiment of the disclosure may only require a key structure, while a control chip, a supply of electricity, and a connecting wire are not required. Hence, the manufacturing cost can be lower than the traditional physical keyboard.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An auxiliary input device for an electronic device, the electronic device comprising a capacitive touch sensor, and the auxiliary input device comprising:
a first key, comprising:
a first upper conductive layer;
a first lower conductive layer, disposed below the first upper conductive layer and having a bottom surface, wherein the bottom surface of the first lower conductive layer has a first specific pattern; and
at least a first support element, disposed between the first upper conductive layer and the first lower conductive layer to maintain a first distance between the first upper conductive layer and the first lower conductive layer, wherein when the auxiliary input device is placed on the capacitive touch sensor and the first key receives a first contact pressure of a conductive object, the first specific pattern of the first lower conductive layer and the first upper conductive layer are electrically conductive with each other so that the capacitive touch sensor detects a contact of the first specific pattern,
wherein when the capacitive touch sensor detects the contact of the first specific pattern, the electronic device executes a first function corresponding to the first specific pattern.

2. The auxiliary input device of claim 1 further comprising a second key, and the second key comprising:
a second upper conductive layer;
a second lower conductive layer, disposed under the second upper conductive layer and having a bottom surface, wherein the bottom surface of the second lower conductive layer has a second specific pattern; and
at least a second support element, disposed between the second upper conductive layer and the second lower conductive layer to maintain a second distance between the second upper conductive layer and the second lower conductive layer, wherein when auxiliary input device is placed on the capacitive touch sensor and the second key receives a second contact pressure of the conductive object, the second specific pattern of the second lower conductive layer and the second upper conductive layer are electrically conductive with each other so that the capacitive touch sensor detects a contact of the second specific pattern,
wherein the first specific pattern and the second specific pattern are different; when the capacitive touch sensor detects the contact of the second specific pattern, the electronic device executes a second function corresponding to the second specific pattern.

3. The auxiliary input device of claim 2 further comprising:
at least one texture, disposed on an upper surface of the auxiliary input device for differentiating a position of the first key and a position of the second key.

4. The auxiliary input device of claim 3, wherein the texture includes at least one of an indentation, a protrusion, a convex surface and a concave surface.

5. The auxiliary input device of claim 2, wherein the first lower conductive layer is configured with a shape of the first specific pattern and the second lower conductive layer is configured with a shape of the second specific pattern.

6. The auxiliary input device of claim 2, wherein the first specific pattern is configured with a plurality of first conductive units, and the second specific pattern is configured with a plurality of second conductive units.

7. The auxiliary input device of claim 6, wherein when the first key receives the first contact pressure of the conductive object, the plurality of first conductive units of the first lower conductive layer contacts the capacitive touch sensor to generate a plurality of first contact events, and the electronic device identifies the first specific pattern according to relative positions of the plurality of first contact events.

8. The auxiliary input device of claim 7, wherein when the second key receives the second contact pressure of the conductive object, the plurality of second conductive units of the second lower conductive layer contacts the capacitive touch sensor to generate a plurality of second contact events, and the electronic device identifies the second specific pattern according to relative positions of the plurality of second contact events.

9. The auxiliary input device of claim 6, wherein the first lower conductive layer includes a third upper conductive layer and a third lower conductive layer, and the third upper conductive layer is disposed above the third lower conductive layer, and a shape of the third upper conductive layer is the same as that of the first upper conductive layer, and the third lower conductive layer comprises the plurality of first conductive units.

10. The auxiliary input device of claim 9, wherein the second lower conductive layer includes a fourth upper conductive layer and a fourth lower conductive layer, wherein the fourth upper conductive layer is disposed above the fourth lower conductive layer, and a shape of the fourth upper conductive layer is the same as that of the second upper conductive layer, and the fourth lower conductive layer comprises the plurality of second conductive units.

11. The auxiliary input device of claim 2 further comprising:
a common conductive layer, configured with a plurality of insulated conductive units, and an entire area of the common conductive layer is smaller than or equal to an area of the capacitive touch sensor, and the first key corresponds to a first subset of the plurality of insulated conductive units and the second key corresponds to a second subset of the plurality of insulated conductive units, wherein the first subset is different from the second subset;
a first conductive wire, connecting the first lower conductive layer and the first subset of the plurality of insulated conductive units, and when the first key receives the first contact pressure of the conductive object, the first upper conductive layer, the first lower conductive layer and the first subset of the plurality of insulated conductive units are electrically conductive with one another so that the first subset of the plurality of insulated conductive units generates a plurality of first contact events on the capacitive touch sensor, and the electronic device identifies the first subset of the plurality of insulated conductive units according to relative positions of the plurality of first contact events; and
a second conductive wire, connecting the second lower conductive layer and the second subset of the plurality of insulated conductive units, and when the second key receives the second contact pressure of the conductive object, the second upper conductive layer, the second lower conductive layer and the second subset of the plurality of insulated conductive units are electrically conductive with one another so that the second subset of the plurality of insulated conductive units generates a plurality of second contact events on the capacitive touch sensor, and the electronic device identifies the second subset of the plurality of insulated conductive units according to relative positions of the plurality of second contact events.

12. An electronic device comprising:
a main body, comprising a capacitive touch sensor; and
an auxiliary input device, disposed on the capacitive touch sensor, and the auxiliary input device comprising:
a first key, comprising:
a first upper conductive layer;
a first lower conductive layer, disposed below the first upper conductive layer and having a bottom surface, wherein the bottom surface of the first lower conductive layer has a first specific pattern; and
at least a first support element, disposed between the first upper conductive layer and the first lower conductive layer to maintain a first distance between the first upper conductive layer and the first lower conductive layer, wherein when the auxiliary input device is placed on the capacitive touch sensor and the first key receive a first contact pressure of a first conductive object, the first specific pattern of the first lower conductive layer and the first upper conductive layer are electrically conductive with each other so that the capacitive touch sensor detects a contact of the first specific pattern,
wherein when the capacitive touch sensor detects the contact of the first specific pattern, the electronic device executes a first function corresponding to the first specific pattern.

13. The electronic device of claim 12, wherein the auxiliary input device further comprises a second key, and the second key comprises:
a second upper conductive layer;
a second lower conductive layer, disposed under the second upper conductive layer and having a bottom surface, wherein the bottom surface of the second lower conductive layer has a second specific pattern; and
at least a second support element, disposed between the second upper conductive layer and the second lower conductive layer to maintain a second distance between the second upper conductive layer and the second lower conductive layer, wherein when the auxiliary input device is placed on the capacitive touch sensor and the second key receives a second contact pressure of the conductive object, the second specific pattern of the second lower conductive layer and the second upper conductive layer are electrically conductive with each other so that the capacitive touch sensor detects a contact of the second specific pattern,
wherein the first specific pattern and the second specific pattern are different; when the capacitive touch sensor detects the contact of the second specific pattern, the electronic device executes a second function corresponding to the second specific pattern.

14. The electronic device of claim 13, wherein the auxiliary input device further comprises:
at least one texture, disposed on an upper surface of the auxiliary input device for differentiating a position of the first key and a position of the second key.

15. The electronic device of claim 14, wherein the texture includes at least one of an indented pattern, a protruded pattern, a convex surface and a concave surface.

16. The electronic device of claim 13, wherein the first specific pattern is configured with a plurality of first conductive units, and the second specific pattern is configured with a plurality of second conductive units.

17. The electronic device of claim 16, wherein when the first key receives the first contact pressure of the conductive object, the plurality of first conductive units of the first lower conductive layer contacts the capacitive touch sensor to generate a plurality of first contact events, and the electronic device identifies the first specific pattern according to relative positions of the plurality of first contact events.

18. The electronic device of claim 17, wherein when the second key receives the second contact pressure of the conductive object, the plurality of second conductive units of the second lower conductive layer contacts the capacitive touch sensor to generate a plurality of second contact events, and the electronic device identifies the second specific pattern according to relative positions of the plurality of second contact events.

19. The electronic device of claim 13, wherein the auxiliary input device further comprises:
a common conductive layer, configured with a plurality of insulated conductive units, and an entire area of the common conductive layer is smaller than or equal to an area of the capacitive touch sensor, and the first key corresponds to a first subset of the plurality of insulated conductive units and the second key corresponds to a second subset of the plurality of insulated conductive units, wherein the first subset is different from the second subset;
a first conductive wire, connecting the first lower conductive layer and the first subset of the plurality of insulated conductive units, and when the first key receives the first contact pressure of the conductive object, the first upper conductive layer, the first lower conductive layer and the first subset of the plurality of insulated conductive units are electrically conductive with one another so that the first subset of the plurality of insulated conductive units generates a plurality of first contact events on the capacitive touch sensor, and the electronic device identifies the first subset of the plurality of insulated conductive units according to relative positions of the plurality of first contact events; and
a second conductive wire, connecting the second lower conductive layer and the second subset of the plurality of insulated conductive units, and when the second key receives the second contact pressure of the conductive object, the second upper conductive layer, the second lower conductive layer and the second subset of the plurality of insulated conductive units are electrically conductive with one another so that the second subset of the plurality of insulated conductive units generates a plurality of second contact events on the capacitive touch sensor, and the electronic device identifies the second subset of the plurality of insulated conductive units according to relative positions of the plurality of second contact events.

20. An electronic system, comprising:
a display device and an electronic device coupled to the display device either via wire or wireless means, the electronic device comprising:
a main body, comprising a capacitive touch sensor; and
an auxiliary input device, disposed on the capacitive touch sensor, and the auxiliary input device comprising:
a first key, comprising:
a first upper conductive layer;
a first lower conductive layer, disposed below the first upper conductive layer and having a bottom surface, wherein the bottom surface of the first lower conductive layer has a first specific pattern; and
at least a first support element, disposed between the first upper conductive layer and the first lower conductive layer to maintain a first distance between the first upper conductive layer and the first lower conductive layer, wherein when the auxiliary input device is placed on the capacitive touch sensor and the first key receives a first contact pressure of a conductive object, the first specific pattern of the first lower conductive layer and the first upper conductive layer are electrically conductive with each other so that the capacitive touch sensor detects a contact of the first specific pattern,
wherein when the capacitive touch sensor detects the contact of the first specific pattern, the electronic device executes a first function corresponding to the first specific pattern for controlling the display device to display an image.

21. The electronic system of claim 20, wherein the first function comprises generating the image by the electronic device and providing the image to the display device for being displayed.

22. The electronic system of claim 20, wherein the first function comprises transmitting an input signal by the electronic device to the display device, and generating and displaying the image by the display device according to the input signal.

23. The electronic system of claim 20, wherein the auxiliary input device further comprises a second key, and the second key comprises:
a second upper conductive layer;
a second lower conductive layer, disposed under the second upper conductive layer and having a bottom surface, wherein the bottom surface of the second lower conductive layer has a second specific pattern; and
at least a second support element, disposed between the second upper conductive layer and the second lower conductive layer to maintain a second distance between the second upper conductive layer and the second lower conductive layer, wherein when the auxiliary input device is placed on the capacitive touch sensor and the second key receives a second contact pressure of the conductive object, the second specific pattern of the second lower conductive layer and the second upper conductive layer are electrically conductive with each other so that the capacitive touch sensor detects a contact of the second specific pattern,
wherein the first specific pattern and the second specific pattern are different; when the capacitive touch sensor detects the contact of the second specific pattern, the electronic device executes a second function corresponding to the second specific pattern.

24. The electronic system of claim 23, wherein the auxiliary input device further comprises:
at least one texture, disposed on an upper surface of the auxiliary input device for differentiating a position of the first key and a position of the second key, wherein the texture includes at least one of an indented pattern, a protruded pattern, a convex surface and a concave surface.
